(19) United States
(12) Patent Application Publication
(10) Pub. No.: US 2007/0080022 A1
(43) Pub. Date: Apr. 12, 2007

(54) Safety connector device

(76) Inventor: Mikio Onoyama, Iizuka-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 11/543,229

(22) Filed: Oct. 5, 2006

(30) Foreign Application Priority Data
Oct. 7, 2005 (JP) P2005-295537

(51) Int. Cl. A62B 35/00

(52) U.S. Cl. 182/36; 182/3

(57) ABSTRACT

In a safety connector device detachably connectable to a safety cable having a plurality of support brackets for supporting the safety cable. A pair of disk-like members are securely attached to end faces of a core member. At least three hook-like members: first, second and third hook-like members are movably supported by the core member, and are cooperated with the pair of disk-like members so that the safety cable is successively connected to and disconnected from the first, second, and third hook-like members in order when the device is moved along the safety cable, with the safety cable is connected to the first hook-like member. A mechanism is constituted so that a connection of the safety cable to the second hook-like member occurs prior to a disconnection of the safety cable from the first hook-like member when the first hook-like member is abutted against one of the support brackets, whereby the device can pass and clear the support bracket concerned during the disconnection of the safety cable from the first hook-like member.

### BACKGROUND OF THE INVENTION

1. Field of the Invention

The present invention relates to a safety connector device adapted for easy detachment to and detachment from a safety cable provided along an altitudinal passage.

2. Description of the Related Art

When a person walks along an altitudinal passage, such as a passage temporarily made on a tall structure on construction, a passage traversing a cliff or the like, a safety cable is provided along the altitudinal passage. The person is outfitted and bound with a safety strip having a karabiner or snap ring securely joined to the free end thereof, and the snap ring is connected to the safety cable, to thereby enable the hazard of falls to be minimized.

The safety cable is supported by a plurality of support brackets, each of which is secured to the safety cable. Thus, when the snap ring encounters one of the support brackets, it cannot pass and clear the support bracket. In this case, the person must once disconnect the snap ring from the safety cable, before the support bracket can be bypassed. Then, the snap ring has to be again connected to the safety cable. Of course, the person may be subjected to the fall hazard during the bypass of the support bracket.

For example, JP-09-511165-A (PCT/GB95/00734) and JP-2000-107307-A disclose safety connector devices which can pass and clear the support brackets without bypassing the support bracket. Nevertheless, the arrangements of these prior art safety connector devices are very complex, and thus the production of the devices is costly. Further, the operation of the devices is very troublesome.

### SUMMARY OF THE INVENTION

Therefore, a main object of the present invention is to provide a novel safety connector device featuring a simply arrangement, which can be produced at low cost, and which can be easily operated.

In accordance with an aspect of the present invention, there is provided a safety connector device detachably connectable to a safety cable having a plurality of support bracket for supporting the safety cable. In the safety connector device, a pair of disk-like members is securely attached to end faces of the core member, and at least three hook-like members: first, second and third hook-like members are movably supported by the core member, and are cooperated with the pair of pair of disk-like members so that the safety cable is successively connected to and disconnected from the first, second, and third hook-like members in order when the device is moved along the safety cable, with the safety cable being connected to the first hook-like member. A mechanism is constituted so that a connection of the safety cable to the second hook-like member occurs prior to a disconnection of the safety cable from the first hook-like member when the first hook-like member is abutted against one of the support brackets, whereby the device can pass and clear the support bracket concerned during the disconnection of the safety cable from the first hook-like member.

Preferably, the mechanism includes a pair of movable members movably attached to the respective disk-like members so that a first force, which is derived from the movement of the device along the safety cable, is generated and exerted on the second hook-like member to thereby cause the connection of the safety cable to the second hook-like member, and then so that a second force, which is derived from the movement of the device along the safety cable, is generated and exerted on the first hook-like member to thereby cause the disconnection of the safety cable from the first hook-like member.

The movable members may be formed as dish-like members having substantially the same diameter as that of the disk-like members.

Preferably, the disk-like members have a longer radial length than an effective radial length of the hook-like members.

Each of the hook-like members may be movable between a closed position and an opened position for a connection of the safety cable to each of the hook-like members and a disconnection of the safety cable from each of the hook-like members. In this case, each of the hook-like members may be provided with an elastic member so as to be elastically biased to the closed position. Preferably, the hook-like members may be arranged around the core member at a regular intervals.

### BRIEF DESCRIPTION OF THE DRAWINGS

The above objects and other objects will be more clearly understood from the description set forth below, with reference to the accompanying drawings, wherein:

FIG. 1 is an elevation view of an embodiment of the safety connector device according to the present invention;

FIG. 2 is a left side view of FIG. 1;

FIG. 3 is a cross-sectional view cut along the line III-III in FIG. 2;

FIG. 4 is a cross-sectional view cut along the line IV-IV in FIG. 2;

FIG. 5 is an elevation view of an embodiment of the safety connector device which is connected to the safety cable according to the present invention;

FIG. 6 is a cross-sectional view cut along the line VI-VI in FIG. 5;

FIG. 7 is a perspective view for explaining the operation of the safety connector device of FIGS. 1 through 6;

FIG. 8 is a plan view for explaining the operation of the safety connector device of FIGS. 1 through 6;

FIG. 9 is a plan view for explaining the operation of the safety connector device of FIGS. 1 through 6;

FIG. 10 is a plan view for explaining the operation of the safety connector device of FIGS. 1 through 6;

FIG. 11 is an elevation view for explaining the operation of the safety connector device of FIGS. 1 through 6; and

FIG. 12 is an elevation view for explaining the operation of the safety connector device of FIGS. 1 through 6.

### DETAILED DESCRIPTION OF THE PREFERRED EMBODIMENTS

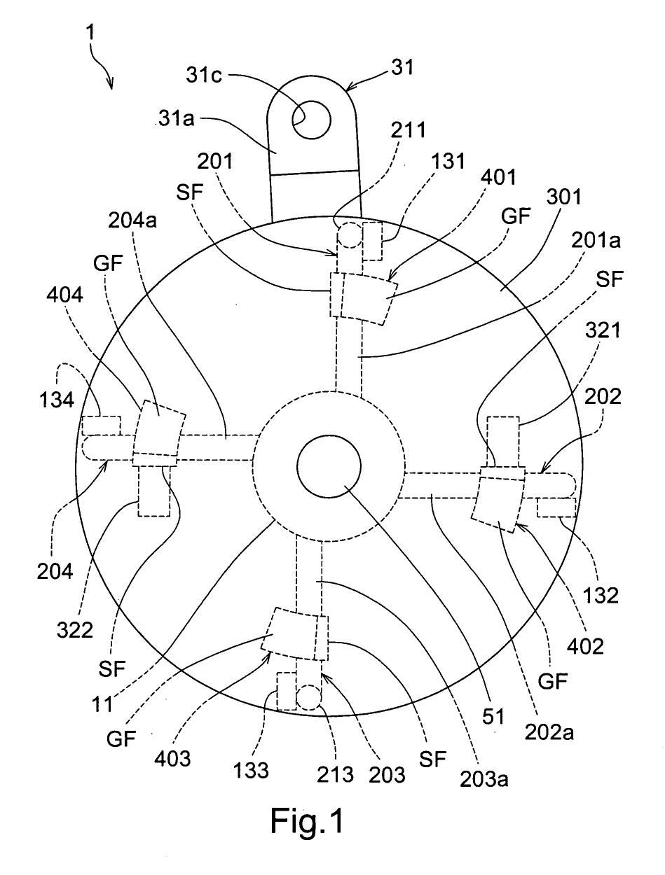

With reference to FIGS. 1 through 12, an embodiment of a safety connector device according to the present invention will be explained below.

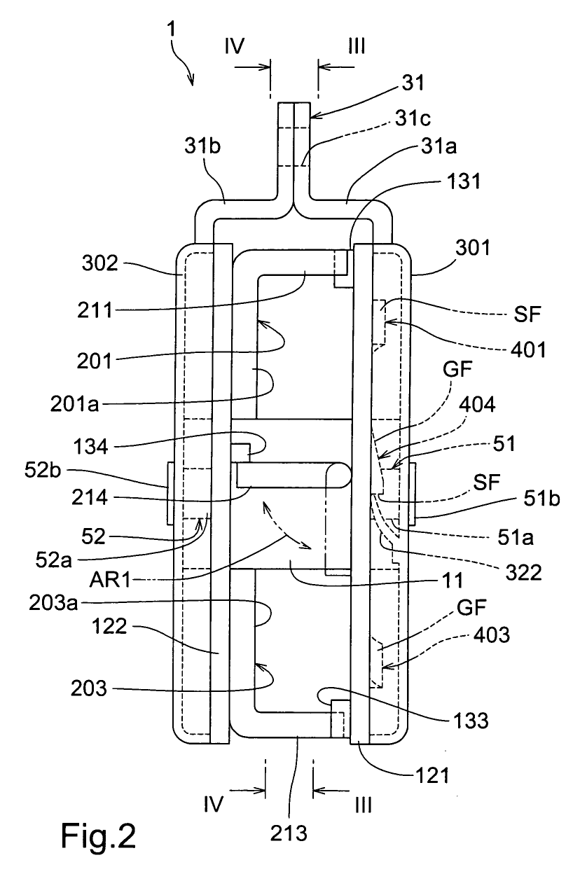

First, referring to FIGS. 1 and 2, a safety connector device 1 according to the present invention includes a cylindrical core member 11, four hook-like members 201, 202, 203 and 204 rotatably supported by the cylindrical core member 11, a pair of disk-like members 121 and 122 securely attached to the end faces of the cylindrical core member 11, and a pair of dish-like members 301 and 302 rotatably mounted on stub-like shafts 51 and 52 which are integrally and outwardly protruded from the centers of the disk-like members 121 and 122.

The hook-like members 201, 202, 203 and 204 are identical to each other, and are substantially radially arranged around the cylindrical core member 11 at regular intervals. Also, the two hook-like members 201 and 203 are symmetrically arranged with respect to the center of the cylindrical core member 11, and the two hook-like members 202 and 204 are symmetrically arranged with respect to the center of the cylindrical core member 11.

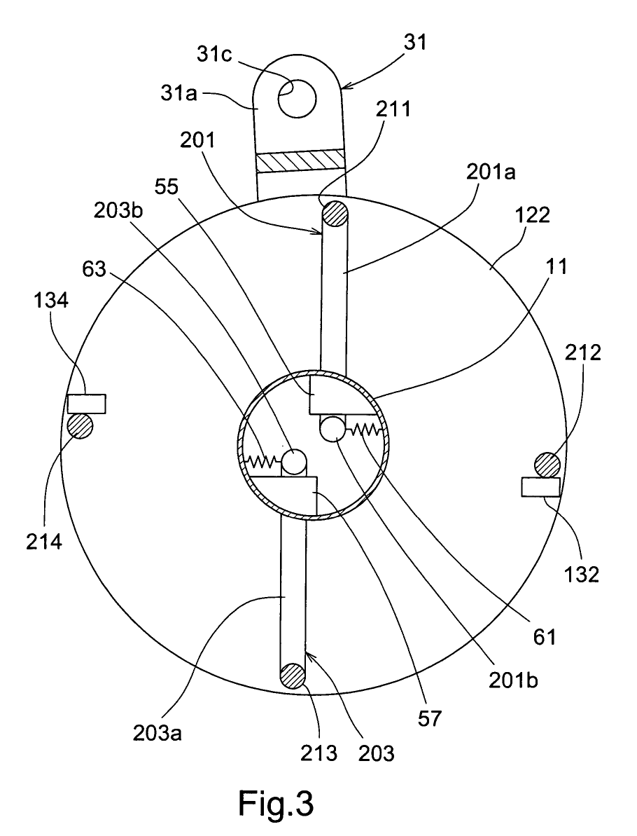

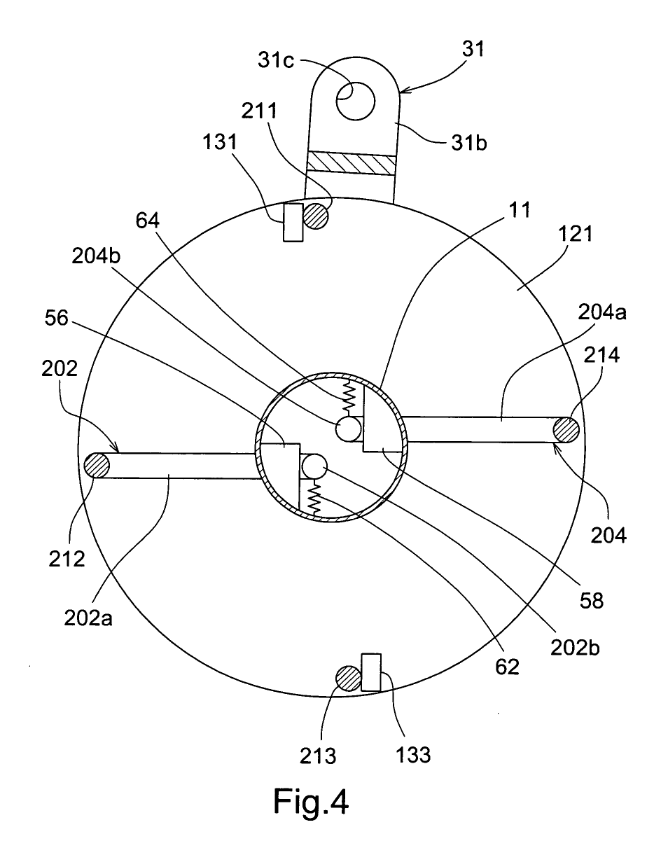

As shown in FIGS. 3 and 4, each of the hook-like members 201, 202, 203 and 204 is formed as a rod member which has a middle portion (201a, 202a, 203a, 204a), an outer terminal portion (211, 212, 213, 214) perpendicularly and integrally extending from the outer end of the middle portion (201a, 202a, 203a, 204a), and an inner terminal portion (201b, 202b, 203b, 204b) perpendicularly and integrally extending from the inner end of the middle portion (201a, 202a, 203a, 204a). Note that each of the outer terminal portions 211, 212, 213 and 214 is longer than the corresponding inner terminal portion (201b, 202b, 203b, 204b).

As is apparent from FIGS. 2 and 3, the middle portions 201a and 203a of the hook-like members 201 and 203 extend through the wall of the cylindrical core member 11 in the immediate vicinity of the disk-like member 122, and are rotatably supported by respective bearing blocks 55 and 57 securely attached to the inner wall face of the cylindrical core member 11.

As shown in FIG. 3, two tension springs 61 and 63 are provided in the cylindrical core member 11 so as to act on the respective inner terminal portions 201b and 203b.

In particular, for example, one end of the tension spring 61 is securely attached to the inner terminal portion 201b, and the other end of the tension spring 61 is securely attached to the inner wall face of the cylindrical core member 11, whereby an elastic rotational force is exerted on the hook-like member 201. Similarly, one end of the tension spring 63 is securely attached to the inner terminal portion 203b, and the other end of the tension spring 63 is securely attached to the inner wall face of the cylindrical core member 11, whereby an elastic rotational force is exerted on the hook-like member 203.

As shown in FIGS. 1, 2 and 4, the disk-like member 121 has hook stoppers 131 and 133 securely attached to the inner wall face thereof, and the stoppers 131 and 133 are arranged so that the free ends of the outer terminal portions 211 and 213 of the hook-like members 201 and 203 are elastically abutted against the respective hook stoppers 131 and 133 due to the provision of the tension springs 61 and 63. Namely, the elastically rotational movements of the hook-like members 201 and 203 are prevented due to the abutting of the outer terminal portions 211 and 213 against the stoppers 131 and 133.

On the other hand, as is apparent from FIGS. 2 and 4, the middle portions 202a and 204a of the hook-like members 202 and 204 extend through the wall of the cylindrical core member 11 in the immediate vicinity of the disk-like member 121, and are rotatably supported by respective bearing blocks 56 and 58 securely attached to the inner wall face of the cylindrical core member 11.

As shown in FIG. 4, two tension springs 62 and 64 are provided in the cylindrical core member 11 so as to act on the respective inner terminal portions 202b and 204b.

In particular, for example, one end of the tension spring 62 is securely attached to the inner terminal portion 202b, and the other end of the tension spring 62 is securely attached to the inner wall face of the cylindrical core member 11, whereby an elastic rotational force is exerted on the hook-like member 202. Similarly, one end of the tension spring 64 is securely attached to the inner terminal portion 204b, and the other end of the tension spring 64 is securely attached to the inner wall face of the cylindrical core member 11, whereby an elastic rotational force is exerted on the hook-like member 204.

As shown in FIG. 3, the disk-like member 122 has hook stoppers 132 and 134 securely attached to the inner wall face thereof, and the stoppers 132 and 134 are arranged so that the free ends of the outer terminal portions 212 and 214 of the hook-like members 202 and 204 are elastically abutted against the respective hook stoppers 132 and 134 due to the provision of the tension springs 62 and 64. Namely, the elastically rotational movements of the hook-like members 202 and 204 are prevented due to the abutting of the respective outer terminal portions 212 and 214 against the stoppers 132 and 134.

In short, as representatively shown in FIG. 2, the hook-like member 204 is movable between a closed position at which the outer terminal portion 214 is shown by a solid line and an opened position at which the outer terminal portion 214 is shown by a phantom line, as indicated by a double-headed arrow AR1. Although the hook-like member 204 usually stays at the closed position due to the elastic force of the tension spring 64 (see: FIG. 4), it can be moved from the closed position to the opened position against the elastic force of the tension spring 64 by exerting an external force on the outer terminal portion 214 of the hook-like member 204. Of course, the same is true for the remaining hook-like member 201, 202 and 203.

As shown in FIG. 2, the respective stub-like shafts 51 and 52 include stub portions 51a and 52a on which the dish-like members 301 and 302 are rotatably mounted, and head portions 51b and 52b integrally formed at the free end of the stub portions 51a and 52a. Namely, the respective dish-like members 301 and 302 are rotatably restrained between the disk-like members 121 and 122 and the head portions 51b and 52b of the stub-like shafts 51 and 52.

As shown in FIGS. 1 and 2, the safety connector device 1 is provided with a shackle member 31 which is formed of shaped tongue elements 31a and 31b partially secured to each other. The shackle member 31 is used to connect the safety connector device 1 to a safety strip 70 with which a person is outfitted and bound. To this end, the shackle member 31 is formed with a hole 3lc so that the shackle member 31 can be detachably connected to a karabiner or snap ring securely joined to the free end of the aforesaid safety strip, as stated hereinafter.

The shackle member 31 also functions a connector for connecting the dish-like members 301 and 302 to each other. Namely, the shaped tongue elements 31a and 31b are securely attached to the peripheral sides of the respective dish-like members 301 and 302 so that both the dish-like members 301 and 302 are simultaneously rotated around the respective stub-like shafts 51 and 52.

As shown in FIGS. 1 and 2, the disk-like member 121 has four stoppers 401, 402, 403 and 404 securely attached to the outer wall face thereof, and the stoppers 401, 402, 403 and 404 are arranged at regular intervals along a circle having the center of the disk-like member 121. Each of the stoppers 401, 402, 403 and 404 features a gradual slope face GF and a sheer face SF, and are oriented along the aforesaid circle, as shown in FIG. 2.

As shown in FIGS. 1 and 2, the dish-like member 301 has a pair of leaf springs 321 and 322 which are securely supported by the inner wall face thereof so that the free ends of leaf springs 321 and 322 are slidably contacted with the outer wall face of the disk-like member 121. The leaf springs 321 and 322 are symmetrically arranged with respect to the center of the dish-like member 301, as shown in FIG. 1.

With the above-mentioned arrangement, when both the dish-like members 301 and 302 are rotated around the stub-like shafts 51 and 52 so that the free ends of the leaf springs 321 and 322 are defined as tailing ends, it is possible to ensure the full rotational movement of both the dish-like members 301 and 302, because the free ends or trailing ends of the leaf springs 321 and 322 can clamber over the stoppers 401 and 403 and the stoppers 402 and 404 along the gradual slopes GF thereof.

On the other hand, when both the dish-like members 301 and 302 are rotated around the stub-like shafts 51 and 52 so that the free ends of the leaf springs 321 and 322 are defined as leading ends, the rotational movement of both the dish-like members 301 and 302 is limited, because the free ends or leading ends of the leaf springs 321 and 322 abuts against either the sheer faces SF of the stoppers 401 and 403 or the sheer faces SF of the stoppers 402 and 404.

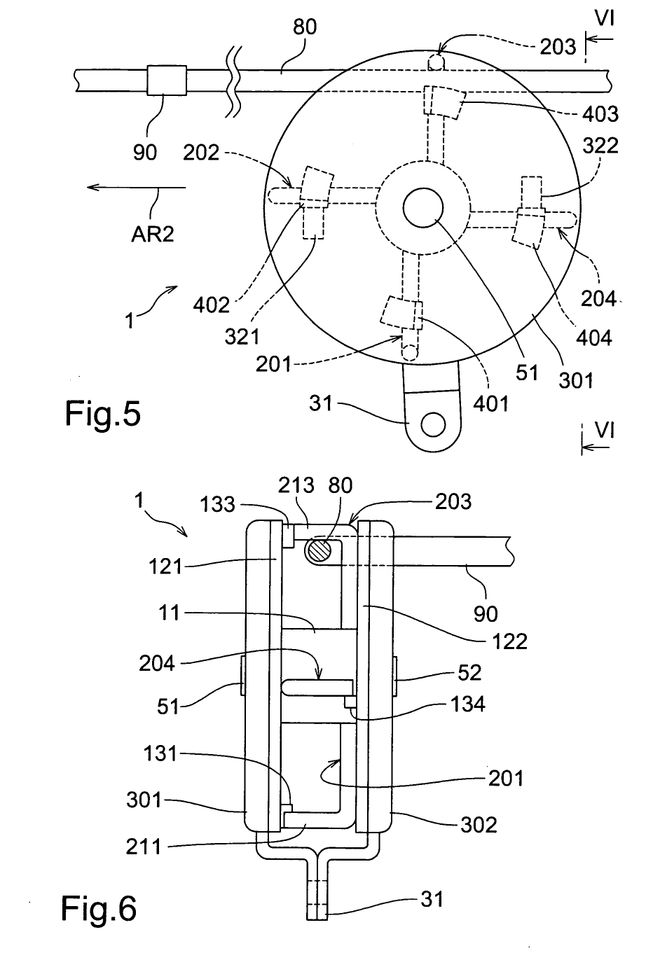

As shown in FIG. 5, a safety cable 80 is provided along an altitudinal passage which may traverse a cliff, and the safety cable 80 is supported by a plurality of support brackets 90, only one of which is representatively illustrated in FIG. 5.

As shown in FIG. 6, the support bracket 90 horizontally extends, and may be securely implanted in the cliff.

As shown in FIG. 8, a safety strip 70 with which a person (not shown) is outfitted and bound has a karabiner or snap ring 71 securely joined to the free end thereof. The snap ring 71 is detachably connected to the shackle member 31 by using the hole 31c.

Next, an operation of the safety connector device is explained below.

When the person intends to walk along the altitudinal passage in a direction indicated by an arrow AR2 (see: FIG. 5), the safety connector device 1 is connected to the safety cable 80 by using, for example, the hook-like member 203, and is vertically suspended from the safety cable 80, with the safety connector being oriented so that the dish-like member 302 is further apart from the person.

Note that the connection of the safety cable 80 to the hook-like member 203 may be carried out by manually rotating the hook-like member 203 from the closed position to the opened position against the elastic force of the tension spring 63 (see: FIG. 3).

While the person walks along the altitudinal passage in the direction indicated by the arrow AR2 (see: FIG. 5), the safety connector device 1 is pulled by the safety strip 70 in a direction indicated by reference AR3, and is moved along the safety cable 80.

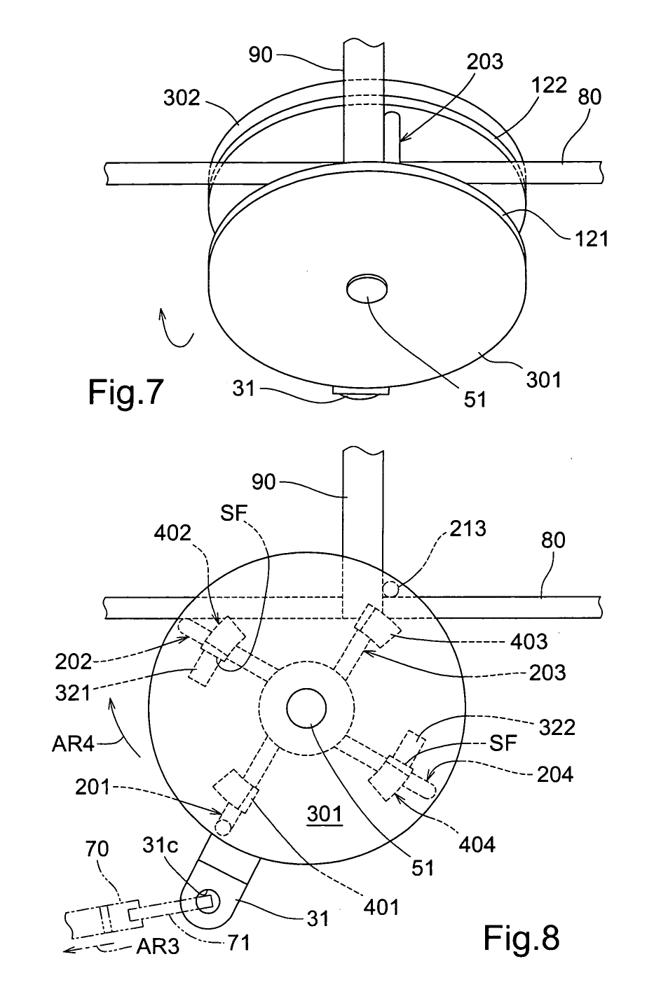

As shown in FIG. 7 which is a perspective view, when the hook-like member 203 is abutted against the support bracket 90, the movement of the safety connector device 1 along the safety cable 80 is temporarily stopped because the outer terminal portion 213 of the hook-like member 203 is abutted against the support bracket 90. As a result, the safety connector device 1 is turned from the vertically-suspended position toward a horizontal position due to the pulling force exerted on the shackle member 31 by the safety strip 70. Note that the safety strip 70 with the snap ring 71 is omitted from FIG. 7 for the sake of convenience of illustration.

As shown in FIG. 8 which is a plan view, when the safety connector device 1 has reached the aforesaid horizontal position, the outer terminal portion 213 of the hook-like member 203 is abutted against the safety cable 80, and then a part of the aforesaid pulling force (AR3) is exerted as a rotational force on the safety connector device 1 so that the safety connector device 1 is turned around the outer terminal portion 213 of the hook-like member 203 in a direction indicated by an arrow AR4, to the free ends of the leaf springs 321 and 322 being abutted against the sheer faces SF of the respective stoppers 402 and 404.

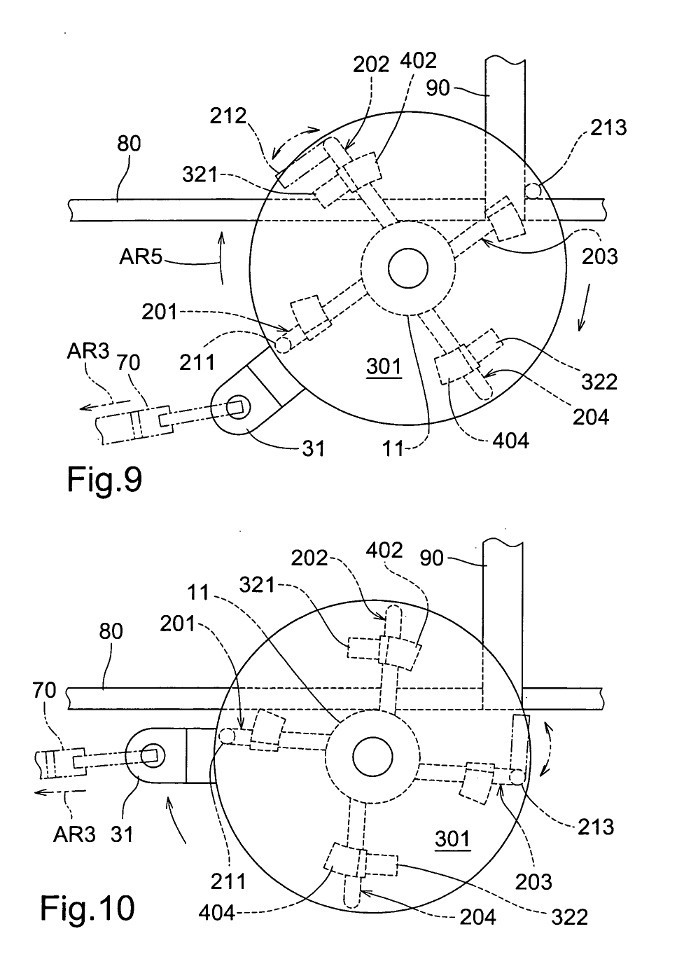

As shown in FIG. 9 which is a plan view, when the pressing force, which is exerted on the safety cable 80 by the outer terminal portion 202a of the hook-like member 202, overcomes the elastic force of the tension spring 62 (see: FIG. 4), the hook-like member 202 is rotated from the closed position to the opened position so that the hook-like member 202 is connected to the safety cable 80. Then, the safety connector device 1 is further turned around the outer terminal portion 213 of the hook-like member 203 by a part of the pulling force (AR3) in a direction indicated by an arrow AR5, so that the outer terminal portion 213 is pressed against the safety cable 80.

Thus, as shown in FIG. 10 which is a plan view, when the safety connector device 1 is turned to a position at which the safety strip 70 is in parallel with the safety cable 80, the hook-like member 203 is rotated from the closed position to the opened position so that not only can the safety cable 80 be disconnected from the hook-like member 203, but also the safety connector device 1 can pass and clear the support bracket 90.

As is apparent from the foregoing, the connection of the safety cable 80 to the hook-like member 202 occurs prior to the disconnection of the safety cable 80 from the hook-like member 203, and thus it is possible to ensure the safety of the walking person.

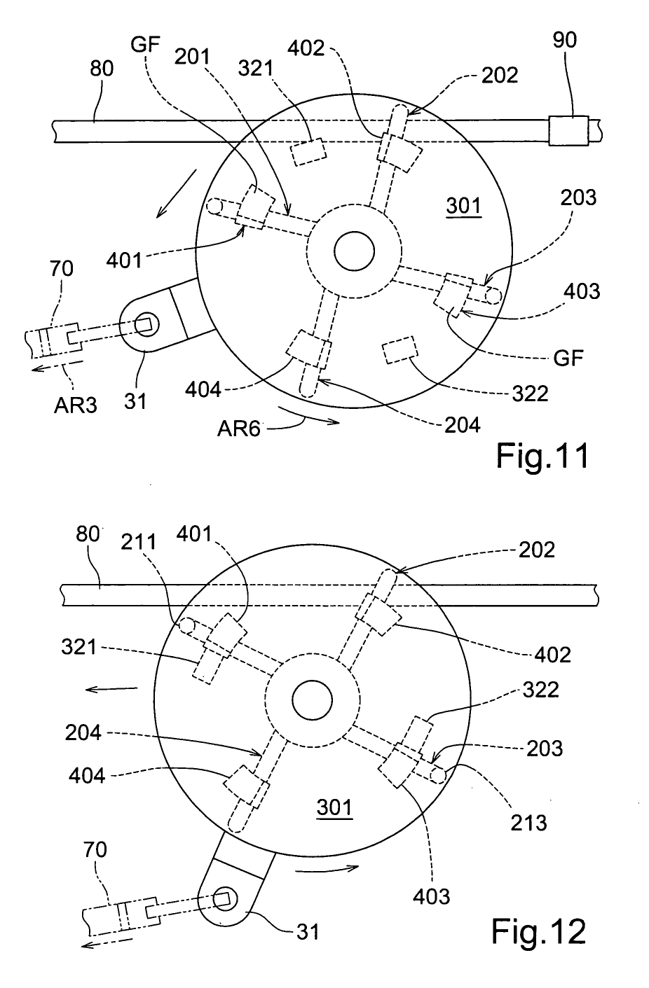

As shown in FIG. 11 which is an elevation view, after the safety cable 80 is disconnected from the hook-like member 203, the safety connector device 1 returns from the horizontal position (see: FIG. 10) to the vertically-suspended position due to the gravity. At this time, both the dish-like members 301 and 302 are rotated in a direction indicated by an arrow AR6, so that the free ends of the leaf springs 321 and 322 clamber over the respective stoppers 401 and 403 along the gradual slopes GF thereof.

Then, as shown in FIG. 12 which is an elevation view, the safety connector device 1 is again pulled by the safety strip 70 so that the free ends of the leaf springs 321 and 322 are abutted against the sheer faces SF of the respective stoppers 401 and 403. Thereafter, when the safety connector device 1 encounters the next support bracket 90, the aforesaid operation is repeated.

In the above-mentioned embodiment, although the safety connector device is provided with the four hook-like members, a number of the hook-like members may be three or more than four. Also, although it is preferable that the number of the hook-like members is even, the number of the hook-like members may be odd.

In the above-mentioned embodiment, a recess may be formed in the outerwall face of the disk-like member 121 as a substitute for each of the stoppers 401, 402, 403 and 404. In particular, the recess is defined by a gradual sloop face corresponding the gradual slope face GF (see: FIG. 1), and a sheer face corresponding the sheer face SF (See: FIG. 1). In this case, when the dish-like member 301 is rotated with respect to the disk-like member 121 so that the free end of each of the leaf springs 321 and 322 is defined as the leading end, the free end concerned is abutted against the sheer face of any one of the recesses. When the respective recesses are substituted for the stoppers 401, 402, 403 and 404, it is possible to narrow the spaces between the disk-like members 121 and 122 and the dish-like members 301 and 302.

Also, the respective disk-like members 121 and 122 may have the leaf springs 321 and 322 formed on the outer wall faces thereof, provided that the stoppers 401, 402, 403 and 404 are provided on the inner well faces of the dish-like members 301 and 302. Also, in this case, each of the stoppers may be substituted for the aforesaid recess defined by the gradual sloop face and the sheer face.

Further, respective ratchet mechanisms may be incorporated in the dish-like members 301 and 302 so that both the dish-like members 301 and 302 are unidirectionally rotated with respect to the disk-like members 121 and 122. Of course, in this case, the stoppers 401, 402, 403 and 404, the leaf springs 321 and 322 are eliminated.

In the above-mentioned embodiment, although the disk-like members 121 and 122 have a radial length equivalent to an effective radial length of the hook-like members 201, 202, 203 and 204, i.e., although the disk-like members 121 and 122 have a diameter which is substantially equivalent to that of a circle defined by the outer terminal portions 211, 212, 213 and 214 of the hook-like members 201, 202, 203 and 204 (see: FIGS. 2, 3 and 4), the diameter of the disk-like members 121 and 122 may be further lengthened so that the support bracket 90 is sufficiently received between the disk-like member 121 and 122, whereby it is possible to smoothly and surely turn the safety connector device from the vertically-suspended position (see: FIG. 6) to the horizontal position (see: FIG. 8).

In this modified embodiment, the space between the disk-like members 121 and 122 may be widened so that the outer terminal portions 211, 212, 213 and 214 of the hook-like members 201, 202, 203 and 204 is further lengthened, whereby each of the hook-like members 201, 202, 203 and 204 can be easily rotated when the safety cable 80 is abutted and pressed thereagainst. In this case, it is preferable that guide members are provided along a peripheral inner wall portion of each of the disk-like members 121 and 122 so that the safety cable 80 can be abutted against each of the outer terminal portions 211, 212, 213 and 214 in the vicinity of the tip end thereof.

Furthermore, in the above-mentioned embodiment, although each of the outer terminal portion 211, 212, 213 and 214 is perpendicularly extends from the corresponding middle portion (201a, 202a, 203a, 204a), it may be suitably shaped so that each of the hook-like members 201, 202, 203 and 204 can be easily rotated when the safety cable 80 is abutted and pressed thereagainst.

Finally, it will be understood by those skilled in the art that the foregoing description is of preferred embodiments of the device, and that various changes and modifications may be made to the present invention without departing from the spirit and scope thereof.

What is claimed is:

1. A safety connector device detachably connectable to a safety cable having a plurality of support bracket for supporting said safety cable, which device comprises:
a core member;
a pair of disk-like members securely attached to end faces of said core member;
at least three hook-like members: first, second and third hook-like members movably supported by said core member and cooperated with said pair of disk-like members so that said safety cable is successively connected to and disconnected from said first, second, and third hook-like members in order when said device is moved along said safety cable, said safety cable being connected to said first hook-like member; and
a mechanism constituted so that a connection of said safety cable to said second hook-like member occurs prior to a disconnection of said safety cable from said first hook-like member when said first hook-like member is abutted against one of said support brackets, whereby said device can pass and clear the support bracket concerned during the disconnection of said safety cable from said first hook-like member.

2. The safety connector device as set forth in claim 1, wherein said mechanism includes a pair of movable members movably attached to said respective disk-like members so that a first force, which is derived from the movement of said device along said safety cable, is generated and exerted on said second hook-like member to thereby cause the connection of said safety cable to said second hook-like member, and then so that a second force, which is derived from the movement of said device along said safety cable, is generated and exerted on said first hook-like member to thereby cause the disconnection of said safety cable from said first hook-like member.

3. The safety connector device as set forth in claim 2, wherein said movable members are formed as dish-like members having substantially the same diameter as that of said disk-like members.

4. The safety connector device as set forth in claim 2, wherein said disk-like members have a longer radial length than an effective radial length of said hook-like members.

5. The safety connector device as set forth in claim 2, wherein each of said hook-like members is movable between a closed position and an opened position for a connection of said safety cable to each of said hook-like members and a disconnection of said safety cable from each of said hook-like members.

6. The safety connector device as set forth in claim 5, wherein each of said hook-like members is provided with an elastic member so as to be elastically biased to said closed position.

7. The safety connector device as set forth in claim 5, wherein said hook-like members are arranged around said core member at a regular intervals.
